(19) United States
(12) Patent Application Publication
(10) Pub. No.: US 2015/0034882 A1
(43) Pub. Date: Feb. 5, 2015

(54) ELECTROCONDUCTIVE POLYACETAL RESIN COMPOSITION AND MOLDED PRODUCT

(71) Applicant: ASAHI KASEI CHEMICALS CORPORATION, Tokyo (JP)

(72) Inventors: Nozomi Inagaki, Tokyo (JP); Takaaki Miyoshi, Tokyo (JP)

(21) Appl. No.: 14/372,601

(22) PCT Filed: Jan. 17, 2013
(86) PCT No.: PCT/JP2013/050794

§ 371 Date: Jul. 16, 2014

(30) Foreign Application Priority Data
Jan. 17, 2012 (JP) 2012-007424

(51) Int. Cl. H01B 1/24; C08L 59/00; C08K 3/04

(52) U.S. Cl. CPC H01B 1/24; C08K 3/04; C08L 59/00; C08K 2201/001; C08L 2203/20; C08L 2205/03
USPC 252/511

(57) ABSTRACT

A polyacetal resin composition of the present invention contains 100 parts by mass of a polyacetal resin (A) and 5 to 30 parts by mass of an electroconductive carbon black (B); and has a volume resistivity of 10² Ω·cm or less measured based on JIS K 7194, and a melt flow rate (MFR) of 8 g/10 min or more and 30 g/10 min or less as measured at a temperature of 190° C. and a load of 2.16 kg based on JIS K 7210.

### TECHNICAL FIELD

The present invention relates to a polyacetal resin composition and a molded product.

### BACKGROUND ART

Since a polyacetal resin is an engineering resin having balanced mechanical properties and excellent slidability, and particularly has excellent slidability, the polyacetal resin is widely used for various precision mechanism parts including a gear, and OA equipment or the like. Since the polyacetal resin is an electrical insulator as other resins, the polyacetal resin has poor removing capacity of static electricity generated when being slid or electroconductivity. Therefore, a polyacetal resin containing an electroconductive filler such as an electroconductive carbon black is used for applications simultaneously requiring slidability and high electroconductivity (for example, see Patent Documents 1 and 2). From the viewpoint of an improvement in mechanical strength and slidability or the like for these electroconductive polyacetal resin compositions, various techniques are disclosed. For example, Patent Document 3 discloses an electroconductive polyacetal resin composition which is obtained by blending specific electroconductive carbon black, polyether esteramide, an acid-modified olefin resin, and an epoxy resin with a polyacetal resin, and has excellent impact properties and slidability. Patent Document 4 discloses a polyacetal resin composition which is obtained by blending electroconductive carbon black, a graft copolymer having a specific structure, a lubricant, and a specific inorganic filler with a polyacetal resin, and has balanced electroconductivity, friction/abrasion properties, moldability, surface peeling, and mechanical properties. Further, Patent Document 5 discloses a polyacetal resin composition which is obtained by adding polylactic acid and electroconductive carbon black to a polyacetal resin and has low deterioration of electroconductivity even if a comparatively long heat history is applied to the polyacetal resin composition during molding.

### LIST OF PRIOR ART DOCUMENTS

### Patent Document

### Patent Document 1: Japanese Patent No. 1978846

### Patent Document 2: National Publication of International Patent Application No. 2004-526596

### Patent Document 3: Japanese Patent Laid-Open No. 2004-10803

### Patent Document 4: Japanese Patent No. 3290317

### Patent Document 5: Japanese Patent Laid-Open No. 2004-231825

### SUMMARY OF INVENTION

### Problems to be Solved by Invention

In recent years, an electroconductive polyacetal resin composition has been progressively integrated with other materials (metal or the like) in various applications. The prolongation of the life of a part, or the like has been required. In order to correspond to the integration and the requisition, excellent dimensional accuracy is required for the polyacetal resin composition from the viewpoint of the integration of the electroconductive polyacetal resin composition with a metal or the like. From the viewpoint of the easiness of design of a part used for a long period, for example, an initial electroconductive level is required to be maintained even after the part is used for a long period (long-period sliding).

However, the polyacetal resin compositions described in Patent Documents 1 to 5 cannot sufficiently meet these requisitions, and the development of a novel material is required.

Then, in view of the above conventional technique, it is an object of the present invention to provide a polyacetal resin composition containing a polyacetal resin and an electroconductive carbon black, having excellent dimensional accuracy, and capable of maintaining an initial electroconductive level even after being slid for a long period, and a molded product thereof.

### Means for Solving Problems

The present inventors made a keen study to solve the above problems. As a result, the present inventors have found that an electroconductive polyacetal resin composition having a specific property solves the problems. The present invention has been thus completed.

That is, the present invention is as follows.

<1> A polyacetal resin composition comprising 100 parts by mass of a polyacetal resin (A) and 5 to 30 parts by mass of an electroconductive carbon black (B),

wherein the polyacetal resin composition has a volume resistivity of 10² Ω·cm or less measured based on JIS K 7194, and

a melt flow rate (MFR) of 8 g/10 min or more and 30 g/10 min or less as measured at a temperature of 190° C. and a load of 2.16 kg based on JIS K 7210.

<2> The polyacetal resin composition according to <1>, wherein the melt flow rate (MFR) as measured at the temperature of 190° C. and the load of 2.16 kg based on JIS K 7210 is 10 g/10 min or more and 30 g/10 min or less.
<3> The polyacetal resin composition according to <1> or <2>, wherein the melt flow rate (MFR) as measured at the temperature of 190° C. and the load of 2.16 kg based on JIS K 7210 is 12 g/10 min or more and 30 g/10 min or less.
<4> The polyacetal resin composition according to any of <1> to <3>, further comprising an epoxy compound (C).
<5> The polyacetal resin composition according to any of <1> to <4>, further comprising an aliphatic alcohol, and/or an ester being formed from a fatty acid and an aliphatic alcohol.
<6> The polyacetal resin composition according to any of <1> to <5>, further comprising an olefin resin.
<7> The polyacetal resin composition according to any of <1> to <6>, further comprising one or more selected from the group consisting of a polyolefin wax, a paraffin wax, a carnauba wax, and a polyamide wax.
<8> The polyacetal resin composition according to any of <1> to <7>, wherein a ratio V₁/V₂ of a melt viscosity V₁ measured under conditions of 210° C. and a shear rate of 100 s⁻¹ based on JIS K 7199 to a melt viscosity V₂ measured under conditions of 210° C. and a shear rate of 1000 s⁻¹ is 1.2 or more and 2.5 or less.
<9> The polyacetal resin composition according to any of <1> to <8>, wherein an amount of residue when being incinerated for 1 hour under conditions of an air atmosphere and 500° C. is 10% by mass or more.
<10> A molded product comprising the polyacetal resin composition according to any of <1> to <9>.

### Advantages of Invention

The present invention can provide an electroconductive polyacetal resin composition having excellent dimensional accuracy and capable of maintaining an initial electroconductive level even after being slid for a long period, and a molded product thereof.

### BRIEF DESCRIPTION OF DRAWINGS

FIG. 1 is a schematic view of a twin-screw extruder used in the present Examples.

FIG. 2 shows the positions of projection pins in a molded piece used for a moldability test in the present Examples.

### MODE FOR CARRYING OUT INVENTION

Hereinafter, an embodiment for implementing the present invention (hereinafter, referred to as “the present embodiment”) will be described in detail.

### <<Polyacetal Resin Composition>>

A polyacetal resin composition of the present embodiment contains 100 parts by mass of a polyacetal resin (A) and 5 to 30 parts by mass of an electroconductive carbon black (B). The polyacetal resin composition has a volume resistivity of 10² Ω·cm or less measured based on JIS K 7194, and a melt flow rate (MFR) of 8 g/10 min or more and 30 g/10 min or less as measured at a temperature of 190° C. and a load of 2.16 kg based on JIS K 7210.

The polyacetal resin composition of the present embodiment has a volume resistivity of 10² Ω·cm or less measured based on JIS K 7194, preferably 10⁰ to 10² Ω·cm, and more preferably 10¹ to 10² Ω·cm. Examples of a method for providing a polyacetal resin composition in which the volume resistivity is within the above range include a method for adjusting the type and content of the electroconductive carbon black (B) to be used. As described also in a method for producing a polyacetal resin composition to be described below, the polyacetal resin composition in which the volume resistivity is within the above range can be obtained also by adjusting various conditions when the polyacetal resin (A) and the electroconductive carbon black (B) are melted and kneaded.

In the polyacetal resin composition of the present embodiment, a melt flow rate (MFR) as measured at a temperature of 190° C. and a load of 2.16 kg based on JIS K 7210 is 8 g/10 min or more, preferably 10 g/10 min or more, and more preferably 12 g/10 min or more. The upper limit value of the melt flow rate (MFR) is 30 g/10 min. The polyacetal resin composition in which the MFR is within the above range has excellent flowability and an extremely low molding fraction defective. Examples of a method for providing the polyacetal resin composition in which the MFR is within the above range include a method for adjusting the molecular weight of the polyacetal resin (A) to be used. As described also in a method for producing a polyacetal resin composition to be described below, the polyacetal resin composition in which the MFR is within the above range can be obtained also by adjusting various conditions when the polyacetal resin (A) and the electroconductive carbon black (B) are melted and kneaded.

The polyacetal resin composition of the present embodiment simultaneously has the volume resistivity in the specific range and the MFR in the specific range. Usually, the volume resistivity and the MFR have characteristics contradictory to each other. However, it is not until the polyacetal resin composition simultaneously meets both the volume resistivity and the MFR that the polyacetal resin composition having excellent dimensional accuracy and capable of maintaining an initial electroconductive level even after being slid for a long period, and a molded product thereof can be obtained. The polyacetal resin composition simultaneously having the volume resistivity in the specific range and the MFR in the specific range can be obtained by adjusting the type and amount of the electroconductive carbon black (B), and adjusting various conditions when the polyacetal resin (A) and the electroconductive carbon black (B) are melted and kneaded as described also in a method for producing a polyacetal resin composition to be described below.

In the polyacetal resin composition of the present embodiment, a ratio V₁/V₂ of a melt viscosity V₁ measured under conditions of 210° C. and a shear rate of 100 s⁻¹ based on JIS K 7199 to a melt viscosity V₂ measured under conditions of 210° C. and a shear rate of 1000 s⁻¹ is preferably 1.2 or more and 2.5 or less, and more preferably 1.3 or more and 2.3 or less. Since the polyacetal resin composition in which the ratio V₁/V₂ of the melt viscosities is within the above range can be molded in wide molding conditions, the degree of freedom of design of a mold is vastly expanded, which can easily provide a molded article having thicknesses different according to positions and having a complicated shape. Examples of a method for providing the polyacetal resin composition in which the ratio V₁/V₂ of the melt viscosities is within the above range include a method for adjusting the type and content of the electroconductive carbon black (B) to be used. As described also in a method for producing a polyacetal resin composition to be described below, the polyacetal resin composition in which the ratio V₁/V₂ of the melt viscosities is within the above range can be obtained also by adjusting various conditions when the polyacetal resin (A) and the electroconductive carbon black (B) are melted and kneaded.

Further, in the polyacetal resin composition of the present embodiment, an amount of residue when being incinerated for 1 hour under conditions of an air atmosphere and 500° C. is preferably 10% by mass or more, and more preferably 12% by mass or more. The upper limit of the amount of residue is, but not particularly limited to, 40% by mass or less, for example.

The polyacetal resin composition in which the amount of residue is within the above range can provide a molded piece having excellent dimensional accuracy. Examples of a method for providing the polyacetal resin composition in which the amount of residue is within the above range include a method for adjusting the type and content of the electroconductive carbon black (B) to be used. As described also in a method for producing a polyacetal resin composition to be described below, the polyacetal resin composition in which the amount of residue is within the above range can be obtained also by adjusting various conditions when the polyacetal resin (A) and the electroconductive carbon black (B) are melted and kneaded.

### [Polyacetal Resin (A)]

Representative examples of the polyacetal resin (A) used in the present embodiment include, but are not particularly limited to, a polyacetal homopolymer obtained by homopolymerizing a monomer of formaldehyde or its cyclic oligomer such as trimer (trioxane) and tetramer (tetraoxane) and substantially consisting of an oxymethylene unit alone, and a polyacetal copolymer obtained by copolymerizing a monomer of formaldehyde or its cyclic oligomer such as trimer (trioxane) and tetramer (tetraoxane) with cyclic ether or cyclic formal such as ethylene oxide, propylene oxide, epichlorohydrin, 1,3-dioxolane, or cyclic formal of glycol or diglycol such as 1,4-butanediol formal. The polyacetal resin (A) is not particularly limited. However, for example, a branched polyacetal copolymer obtained by copolymerizing monofunctional glycidyl ether and a crosslinked polyacetal copolymer obtained by copolymerizing multifunctional glycidyl ether can also be used. Further, examples of the polyacetal resin (A) that can be used also include, but are not particularly limited to, a polyacetal homopolymer having a block component obtained by polymerizing a monomer of formaldehyde or its cyclic oligomer in the presence of a compound having functional groups such as a hydroxyl group at one or both terminals, for example, polyalkylene glycol, and a polyacetal copolymer having a block component obtained by copolymerizing a monomer of formaldehyde or its cyclic oligomer such as trimer (trioxane) and tetramer (tetraoxane) with cyclic ether or cyclic formal in the presence of a compound having functional groups such as a hydroxyl group at one or both terminals, for example, hydrogenated polybutadiene glycol. As described above, in the present embodiment, both the polyacetal homopolymer and the polyacetal copolymer can be used as the polyacetal resin (A). The polyacetal copolymer is preferable.

Generally, the comonomer such as 1,3-dioxolane is preferably used in an amount of 0.1 to 60 mol %, more preferably 0.1 to 20 mol %, and still more preferably 0.13 to 10 mol %, based on 1 mol of trioxane.

The polyacetal copolymer used for the present embodiment has a melting point of preferably 162° C. to 173° C., more preferably 167° C. to 173° C., and still more preferably 167° C. to 171° C. The polyacetal copolymer having a melting point of 167° C. to 171° C. can be obtained by using about 1.3 to 3.5 mol % of the comonomer based on trioxane. In the present embodiment, the melting point of the polyacetal copolymer can be measured by DSC.

As a polymerization catalyst in polymerizing the polyacetal copolymer, cationic active catalysts such as Lewis acid, protonic acid, and their esters or anhydrides are preferable. Examples of the Lewis acid include, but are not particularly limited to, halides of boric acid, tin, titanium, phosphorus, arsenic, and antimony. Specific examples thereof include boron trifluoride, tin tetrachloride, titanium tetrachloride, phosphorus pentafluoride, phosphorus pentachloride, antimony pentafluoride, and their complex compounds or salts. Specific examples of the protonic acids and their esters or anhydrides include, but are not particularly limited to, perchloric acid, trifluoromethanesulfonic acid, t-butyl perchlorate, acetyl perchlorate, and trimethyloxonium hexafluorophosphate. Among them, boron trifluoride; boron trifluoride hydrate; and coordination complex compounds of oxygen atom or sulfur atom-containing organic compounds with boron trifluoride are preferable. Specifically, preferable examples thereof include diethyl ether of boron trifluoride and di-n-butyl ether of boron trifluoride.

Examples of the polymerization method of the polyacetal copolymer include conventionally known methods such as those described in U.S. Pat. No. 3,027,352, U.S. Pat. No. 3,803,094, German Patent No. 1161421, German Patent No. 1495228, German Patent No. 1720358, German Patent No. 3018898, Japanese Patent Laid-Open No. 58-98322, and Japanese Patent Laid-Open No. 7-70267. The polyacetal copolymer obtained by the above method has a thermally unstable terminal portion [—(OCH₂)ₙ—OH group] so that the polyacetal copolymer cannot be possibly applicable to practical use as it is. Then, treatment for decomposing and removing the unstable terminal portion is preferably conducted. For example, a specific treatment for decomposing and removing an unstable terminal portion to be shown below is preferably performed. The specific treatment for decomposing and removing an unstable terminal portion means a method for heat treating the polyacetal copolymer at a temperature equal to or more than the melting point of the polyacetal copolymer and 260° C. or less in the presence of at least one quaternary ammonium compound represented by the following general formula (1), while melting the polyacetal copolymer.

[R¹R²R³R⁴N⁺]ₙX⁻ⁿ formula (1)

wherein each of R¹, R², R³, and R⁴ independently represents an unsubstituted or substituted C₁-C₃₀ alkyl group; a C₆-C₂₀ aryl group; an aralkyl group wherein an unsubstituted or substituted C₁-C₃₀ alkyl group is substituted with at least one C₆-C₂₀ aryl group; or an alkylaryl group wherein a C₆-C₂₀ aryl group is substituted with at least one unsubstituted or substituted C₁-C₃₀ alkyl group, wherein the unsubstituted or substituted alkyl group is linear, branched, or cyclic. The substituent of the above substituted alkyl group is a halogen, a hydroxyl group, an aldehyde group, a carboxyl group, an amino group, or an amide group. The hydrogen atom of each of the aryl group, the aralkyl group, and the alkylaryl group may be substituted with a halogen. represents an integer of 1 to 3. X represents a hydroxyl group, or an acid residue of a C₁-C₂₀ carboxylic acid, a hydroacid excluding a hydrogen halide, an oxoacid, an inorganic thioacid, or a C₁-C₂₀ organic thioacid.

The quaternary ammonium compound used for the present embodiment is not particularly limited as long as the quaternary ammonium compound is represented by the above general formula (1). However, each of R¹, R², R³, and R⁴ in the general formula (1) is independently preferably a C₁-C₅ alkyl group or a C₂-C₄ hydroxyalkyl group. Among them, at least one of R¹, R², R³, and R⁴ is particularly preferably a hydroxyethyl group. Specific examples of the quaternary ammonium compound include, but are not particularly limited to, hydroxides such as tetramethyl ammonium, tetraethyl ammonium, tetrapropyl ammonium, tetra-n-butyl ammonium, cetyl trimethyl ammonium, tetradecyl trimethyl ammonium, 1,6-hexamethylene bis(trimethylammonium), decamethylene-bis-(trimethylammonium), trimethyl-3-chloro-2-hydroxypropyl ammonium, trimethyl(2-hydroxyethyl)ammonium, triethyl(2-hydroxyethyl) ammonium, tripropyl(2-hydroxyethyl)ammonium, tri-n-butyl(2-hydroxyethyl)ammonium, trimethyl benzyl ammonium, triethyl benzyl ammonium, tripropyl benzyl ammonium, tri-n-butylbenzyl ammonium, trimethyl phenyl ammonium, triethyl phenyl ammonium, trimethyl-2-oxyethyl ammonium, monomethyl trihydroxyethyl ammonium, monoethyl trihydroxyethyl ammonium, octadecyl tri(2-hydroxyethyl)ammonium, and tetrakis(hydroxyethyl)ammonium; hydroacid salts such as hydrochloric acid, bromic acid, and fluoric acid; oxoacid salts such as sulfuric acid, nitric acid, phosphoric acid, carbonic acid, boric acid, chloric acid, iodic acid, silicic acid, perchloric acid, chlorous acid, hypochlorous acid, chlorosulfuric acid, amidosulfuric acid, disulfuric acid, and tripolyphosphoric acid; thioacid salts such as thiosulfuric acid; and carboxylic acid salts such as formic acid, acetic acid, propionic acid, butanoic acid, isobutyric acid, pentanoic acid, caproic acid, caprylic acid, capric acid, benzoic acid, and oxalic acid. Of these, hydroxide (OH⁻) and salts of sulfuric acid (HSO₄⁻ and SO₄²⁻), carbonic acid (HCO₃⁻ and CO₃²⁻), boric acid (B(OH)₄⁻), and carboxylic acid are preferable. Among the carboxylic acids, formic acid, acetic acid, and propionic acid are particularly preferable. These quaternary ammonium compounds may be used singly or in combinations of two or more. The quaternary ammonium compound is perfectly acceptably used in combination with a known decomposition accelerator for an unstable terminal portion such as an amine, e.g., ammonia or triethylamine.

The amount of the quaternary ammonium compound to be used is preferably 0.05 to 50 ppm by mass, and more preferably 1 to 30 ppm by mass in terms of the amount of nitrogen derived from the quaternary ammonium compound represented by the following formula (2), based on the total mass of the polyacetal copolymer and the quaternary ammonium compound.

P×14/Q Formula (2)

wherein P represents the concentration (ppm by mass) of the quaternary ammonium compound, based on the polyacetal copolymer; numeral 14 is the atomic weight of nitrogen; and Q represents the molecular weight of the quaternary ammonium compound.

When the amount of the quaternary ammonium compound added is within the above range, the decomposition and removal rate of the unstable terminal portion is increased, which improves the color tone of the polyacetal copolymer after the unstable terminal portion is decomposed and removed.

The treatment for decomposing and removing the unstable terminal portion of the polyacetal resin (A) used for the present embodiment is achieved by heat treating the polyacetal copolymer at a temperature equal to or more than the melting point of the polyacetal copolymer and 260° C. or less, while melting it. Examples of an apparatus to be used for the decomposition and removal treatment include, but are not particularly limited to, an extruder and a kneader. Heat treatment is preferably performed by using the above apparatus as the above decomposition and removal treatment. Formaldehyde generated upon decomposition is preferably removed under reduced pressure. Examples of a method for adding the quaternary ammonium compound include, but are not particularly limited to, a method for adding it as an aqueous solution in a step of deactivating the polymerization catalyst and a method for spraying it to a polyacetal copolymer powder produced by polymerization. Either method is usable insofar as the quaternary ammonium compound is added during the heat treatment step of the polyacetal copolymer. It may be poured in an extruder. When a filler or pigment is blended by using an extruder or the like, the quaternary ammonium compound may be spread on resin pellets, followed by removal operation of the unstable terminal portion in a blending step.

The removal operation of the unstable terminal portion may be performed after deactivation of the polymerization catalyst in the polyacetal copolymer obtained by polymerization or without deactivating the catalyst. Typical examples of the deactivation operation of the polymerization catalyst include, but are not particularly limited to, a method for neutralizing and deactivating the polymerization catalyst in an aqueous basic solution such as an amine. It is also effective to heat the polyacetal copolymer at a temperature equal to or less than the melting point of the polyacetal copolymer in an inert gas atmosphere and reduce the polymerization catalyst by evaporation, thereby performing the removal operation of the unstable terminal portion without deactivating the polymerization catalyst.

The polyacetal copolymer hardly containing the unstable terminal portion and having very excellent thermal stability can be obtained by the above specific treatment for decomposing and removing an unstable terminal portion.

### [Electroconductive Carbon Black (B)]

The electroconductive carbon black (B) used for the present embodiment is not particularly limited. Electroconductive carbon black is preferable, which has an amount of dibutyl phthalate (DBP) oil absorption (ASTM D2415-65T) of 100 mL/100 g or more and a BET specific surface area of 20 m²/g or more according to a nitrogen adsorption method. As the value of the amount of dibutyl phthalate oil absorption is larger, even the low content of the electroconductive carbon black (B) can impart high electroconductivity to the polyacetal resin composition. From the viewpoint that the content of the carbon black can be reduced while high electroconductivity is maintained, the amount of dibutyl phthalate oil absorption is preferably 300 mL/100 g or more, more preferably 350 mL/100 g or more, and still more preferably 400 mL/100 g or more. In this case, the upper limit of the amount of dibutyl phthalate oil absorption is, but not particularly limited to, 600 mL/100 g, for example.

On the other hand, from the viewpoint of obtaining a molded article having more excellent dimensional accuracy, electroconductive carbon black having an amount of dibutyl phthalate oil absorption of less than 300 mL/100 g is preferably used. The amount of dibutyl phthalate oil absorption is more preferably 50 mL/100 g or more and less than 300 mL/100 g, and still more preferably 100 mL/100 g or more and 200 mL/100 g or less.

As the value of the BET specific surface area of the electroconductive carbon black (B) is higher, the dispersibility of the electroconductive carbon black (B) in the polyacetal resin composition is improved. Therefore, the BET specific surface area of the electroconductive carbon black (B) according to a nitrogen adsorption method is more preferably 20 m²/g or more, and still more preferably 50 m²/g or more. The upper limit of the BET specific surface area is, but not particularly limited to, 2000 m²/g, for example.

The BET specific surface area according to the nitrogen adsorption method and the amount of dibutyl phthalate oil absorption (ASTM D2415-65T) of the electroconductive carbon black (B) are information disclosed by electroconductive carbon black manufacturers. A person skilled in the art can appropriately select an electroconductive carbon black used based on the information.

The primary particle diameter of the electroconductive carbon black (B) is preferably 0.05 μm or less. For example, the primary particle diameter of the electroconductive carbon black (B) is obtained by observing the electroconductive carbon black (B) at a magnification of 10,000 times to 50,000 times by a transmission electron microscope (TEM), measuring major axes and minor axes of at least 100 electroconductive carbon black (B) particles, and calculating the average value thereof.

The electroconductive carbon black (B) may be used singly or in combinations of two or more.

In the polyacetal resin composition of the present embodiment, the content of the electroconductive carbon black (B) is 5 to 30 parts by mass based on 100 parts by mass of the polyacetal resin (A). When an electroconductive carbon black having an amount of dibutyl phthalate oil absorption of 300 mL/100 g or more is used, the content of the electroconductive carbon black (B) is preferably 5 to 15 parts by mass, more preferably 5 to 10 parts by mass, and still more preferably 6 to 9 parts by mass, based on 100 parts by mass of the polyacetal resin (A). On the other hand, when an electroconductive carbon black having an amount of dibutyl phthalate oil absorption of less than 300 mL/100 g is used, the content of the electroconductive carbon black (B) is preferably 10 to 30 parts by mass, and more preferably 15 to 25 parts by mass, based on 100 parts by mass of the polyacetal resin (A).

The content of the electroconductive carbon black (B) is 5 parts by mass or more based on 100 parts by mass of the polyacetal resin (A), and thereby a polyacetal resin composition having sufficient electroconductivity can be obtained. When the content is 30 parts by mass or less, a polyacetal resin composition can be obtained, which has balanced various characteristics and an extremely low molding fraction defective.

### [Epoxy Compound (C)]

The polyacetal resin composition of the present embodiment can further contain an epoxy compound (C) as needed. The epoxy compound (C) is preferably a mono- or multifunctional glycidyl derivative, or a compound having an epoxy group produced by oxidizing a compound having an unsaturated bond. In the polyacetal resin composition of the present embodiment, the content of the epoxy compound (C) is preferably 0.05 to 10 parts by mass, and more preferably 0.5 to 5 parts by mass, based on 100 parts by mass of the polyacetal resin (A).

Specific examples of the epoxy compound (C) include, but are not particularly limited to, 2-ethylhexyl glycidyl ether, 2-methyloctyl glycidyl ether, lauryl glycidyl ether, stearyl glycidyl ether, behenyl glycidyl ether, ethylene glycol diglycidyl ether, polyethylene glycol diglycidyl ether (ethylene oxide units: 2 to 30), propylene glycol diglycidyl ether (propylene oxide units: 2 to 30), neopentyl glycol diglycidyl ether, 1,6-hexanediol diglycidyl ether, glycerine diglycidyl ether, glycerine triglycidyl ether, trimethylolpropane diglycidyl ether, trimethylolpropane triglycidyl ether, and bisphenol A diglycidyl ether.

Other specific examples of the epoxy compound (C) include, but are not particularly limited to, hydrogenated bisphenol A diglycidyl ether, sorbitan monoester diglycidyl ether, sorbitan monoester triglycidyl ether, pentaerythritol triglycidyl ether, pentaerythritol tetraglycidyl ether, diglycerine triglycidyl ether, diglycerine tetraglycidyl ether, a condensate of cresol novolac and epichlorohydrin (epoxy equivalent: 100 to 400, softening point: 20 to 150° C.), glycidyl methacrylate, glycidyl ester of coconut fatty acid, and glycidyl ester of soybean fatty acid.

These epoxy compounds (C) may be used singly or in combinations of two or more.

### [Curable Additive for Epoxy Compound (C)]

The polyacetal resin composition of the present embodiment can contain a curable additive for an epoxy compound (C) in addition to the epoxy compound (C). As the curable additive for the epoxy compound (C), for example, a basic nitrogen compound and a basic phosphorus compound are generally used. Any other compound having an epoxy-curing action (including a cure-accelerating action) can also be used.

In the polyacetal resin composition of the present embodiment, the content of the curable additive for the epoxy compound (C) is preferably 0.01 to 5 parts by mass, and more preferably 0.05 to 3 parts by mass, based an 100 parts by mass of the polyacetal resin (A).

Specific examples of the curable additive for the epoxy compound (C) include, but are not particularly limited to, imidazole; substituted imidazoles such as 1-hydroxyethyl-2-methylimidazole, 1-cyanoethyl-2-heptadecylimidazole, and 1-vinyl-2-phenylimidazole; aliphatic secondary amines such as octylmethylamine and laurylmethylamine; aromatic secondary amines such as diphenylamine and ditolylamine; aliphatic tertiary amines such as trilaurylamine, dimethyloctylamine, dimethylstearylamine, and tristearylamine; aromatic tertiary amines such as tritolylamine and triphenylamine; morpholine compounds such as cetylmorpholine, octylmorpholine, and p-methylbenzylmorpholine; addition products obtained by adding an alkylene oxide to dicyandiamide, melamine, and urea or the like (the number of moles added: 1 to 20 moles); and phosphorus compounds such as triphenylphosphine, methyldiphenylphosphine, and tritolylphosphine. These curable additives for the epoxy compound (C) may be used singly or in combinations of two or more.

### [Other Additives]

The polyacetal resin composition of the present embodiment may further contain a compound containing formaldehyde-reactive nitrogen, an antioxidant, a catching agent of formic acid, a weathering (light) stabilizer, and a mold release agent as needed without damaging the object achievement of the present invention. The polyacetal resin composition may preferably contain each additive in the range of 0.01 to 10 parts by mass based on 100 parts by mass of the polyacetal resin (A).

### (Compound Containing Formaldehyde-Reactive Nitrogen)

Examples of the compound containing formaldehyde-reactive nitrogen include, but are not particularly limited to, polyamide resins such as Nylon 4-6, Nylon 6, Nylon 6-6, Nylon 6-10, Nylon 6-12, and Nylon 12 and polymers thereof (for example, Nylon 6/6-6/6-10 and Nylon 6/6-12). Additional examples thereof include acrylamide and derivatives thereof, and copolymers of acrylamide or a derivative thereof and another vinyl monomer. Specifically, examples thereof include poly-β-alanine copolymers obtained by polymerizing acrylamide or a derivative thereof and another vinyl monomer in the presence of a metal alcoholate. Other examples thereof include amide compounds, amino-substituted triazine compounds, adducts of amino-substituted triazine compounds with formaldehyde, condensates between amino-substituted triazine compounds and formaldehyde, urea, urea derivatives, hydrazine derivatives, imidazole compounds, and imide compounds.

Specific examples of the amide compound include, but are not particularly limited to, polycarboxylic acid amides such as isophthalic diamide, and anthranilamide.

Specific examples of the amino-substituted triazine compound include, but are not particularly limited to, 2,4-diamino-sym-triazine, 2,4,6-triamino-sym-triazine (melamine), N-butylmelamine, N-phenylmelamine, N,N-diphenylmelamine, N,N-diallylmelamine, benzoguanamine(2,4-diamino-6-phenyl-sym-triazine), acetoguanamine(2,4-diamino-6-methyl-sym-triazine), and 2,4-diamino-6-butyl-sym-triazine.

Specific examples of the adduct of an amino-substituted triazine compound with formaldehyde include, but are not particularly limited to, N-methylolmelamine, N,N′-dimethylolmelamine, and N,N′,N″-trimethylolmelamine.

Specific examples of the condensate of an amino-substituted triazine compound and formaldehyde include, but are not particularly limited to, melamine-formaldehyde condensate.

Examples of the urea derivative include, but are not particularly limited to, N-substituted urea, urea condensates, ethylene urea, hydantoin compounds, and ureido compounds. Specific examples of the N-substituted urea include, but are not particularly limited to, methyl urea, alkylenebis urea, and aryl-substituted urea obtained by substitution with a substituent such as an alkyl group. Specific examples of the urea condensate include, but are not particularly limited to, a condensate of urea and formaldehyde. Specific examples of the hydantoin compound include, but are not particularly limited to, hydantoin, 5,5-dimethylhydantoin, and 5,5-diphenylhydantoin. Specific examples of the ureido compound include, but are not particularly limited to, allantoin.

Examples of the hydrazine derivative include, but are not particularly limited to, a hydrazide compound. Specific examples of the hydrazide compound include, but are not particularly limited to, a dicarboxylic acid dihydrazide. Further specific examples thereof include malonic acid dihydrazide, succinic acid dihydrazide, glutaric acid dihydrazide, adipic acid dihydrazide, pimelic acid dihydrazide, suberic acid dihydrazide, azelaic acid dihydrazide, sebacic acid dihydrazide, dodecanedioic acid dihydrazide, isophthalic acid dihydrazide, phthalic acid dihydrazide, and naphthalene 2,6-dicarboxylic acid dihydrazide.

Specific examples of the imidazole compound include, but are not particularly limited to, imidazole, 1-methylimidazole, 2-methylimidazole, and 1,2-dimethylimidazole.

Specific examples of the imide compound include, but are not particularly limited to, succinimide, glutarimide, and phthalimide.

These compounds containing formaldehyde-reactive nitrogen may be used singly or in combinations of two or more.

As these compounds containing formaldehyde-reactive nitrogen, melamine is particularly preferable.

### (Antioxidant)

As the antioxidant, hindered phenol antioxidants are preferable. Specific examples of the hindered phenol antioxidants include, but are not particularly limited to, n-octadecyl-3-(3′,5′-di-t-butyl-4′-hydroxyphenyl)-propionate, n-octadecyl-3-(3′-methyl-5′-t-butyl-4′-hydroxyphenyl)-propionate, n-tetradecyl-3-(3′,5′-di-t-butyl-4′-hydroxyphenyl)-propionate, 1,6-hexanediol-bis-[3-(3,5-di-t-butyl-4-hydroxyphenyl)-propionate], 1,4-butanediol-bis-[3-(3,5-di-t-butyl-4-hydroxyphenyl)-propionate], triethylene-glycol-bis-[3-(3-t-butyl-5-methyl-4-hydroxyphenyl)-propionate], and pentaerythritol tetrakis[methylene-3-(3′,5′-di-t-butyl-4′-hydroxyphenyl) propionate]methane. Of these antioxidants, preferable examples include triethylene-glycol-bis-[3-(3-t-butyl-5-methyl-4-hydroxyphenyl)-propionate] and pentaerythritol tetrakis[methylene-3-(3′,5′-di-t-butyl-4′-hydroxyphenyl)propionate]methane. These antioxidants are used singly or in combinations of two or more.

### (Catching Agent of Formic Acid)

Examples of the catching agents of formic acid include, but are not particularly limited to, the above amino-substituted triazine compound, the condensate of the amino-substituted triazine compound and formaldehyde, for example, melamine-formaldehyde condensate. Examples of other catching agents of formic acid include, but are not particularly limited to, a hydroxide, an inorganic acid salt, or an alkoxide of an alkali metal or an alkaline earth metal. More specifically, examples thereof include hydroxide of sodium, potassium, magnesium, calcium, or barium, and carbonate, phosphate, silicate, and borate of the above metals. These catching agents of formic acid are used singly or in combinations of two or more.

### (Weathering (Light) Stabilizer)

The weathering (light) stabilizers are preferably one or more selected from benzotriazole type ultraviolet absorbers, anilide oxalate type ultraviolet absorbers, and hindered amine type light stabilizers.

Specific examples of the benzotriazole type ultraviolet absorbers include, but are not particularly limited to, 2-(2′-hydroxy-5′-methyl-phenyl)benzotriazole, 2-(2′-hydroxy-3′,5′-di-t-butyl-phenyl)benzotriazole, 2-[2′-hydroxy-3′,5′-bis(α,α-dimethylbenzyl)phenyl]-2H-benzotriazole, 2-[2′-hydroxy-3′,5′-bis-(α,α-dimethylbenzyl)phenyl]-2H-benzotriazole, and 2-(2′-hydroxy-4′-octoxyphenyl)benzotriazole. Specific examples of the anilide oxalate type ultraviolet absorbers include, but are not particularly limited to, 2-ethoxy-2′-ethyloxalic acid bisanilide, 2-ethoxy-5-t-butyl-2′-ethyloxalic acid bisanilide, and 2-ethoxy-3′-dodecyloxalic acid bisanilide. The benzotriazole type ultraviolet absorbers are preferably 2-[2′-hydroxy-3′,5′-bis-(α,α-dimethylbenzyl)phenyl]-2H-benzotriazole and 2-(2′-hydroxy-3′,5′-di-t-butyl-phenyl)benzotriazole. These benzotriazole type ultraviolet absorbers and anilide oxalate type ultraviolet absorbers are used singly or in combinations of two or more.

Examples of the hindered amine type light stabilizers include, but are not particularly limited to, N,N′,N″,N′″-tetrakis-(4,6-bis(butyl-(N-methyl-2,2,6,6-tetramethylpiperidine-4-yl)amino)-triazine-2-yl)-4,7-diazadecane-1,10-diamine, a polycondensate of dibutylamine 1,3,5-triazine N,N′-bis(2,2,6,6-tetramethyl-4-piperidyl-1,6-hexamethylenediamine and N-(2,2,6,6-tetramethyl-4-piperidyl)butylamine, poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], a condensate of dimethyl succinate and 4-hydroxy-2,2,6,6-tetramethyl-1-piperidine ethanol, a reaction product of decanedioic bis(2,2,6,6-tetramethyl-1(octyloxy)-4-piperidinyl)ester, 1,1-dimethylethylhydroperoxide and octane, bis(1,2,2,6,6-pentamethyl-4-piperidyl)[[3,5-bis(1,1-dimethylethyl)-4-hydroxyphenyl]methyl]butylmalonate, methyl-1,2,2,6,6-pentamethyl-4-piperidyl sebacate, bis(2,2,6,6-tetramethyl-4-piperidyl)sebacate, bis(N-methyl-2,2,6,6-tetramethyl-4-piperidinyl)sebacate, and a condensate of 1,2,3,4-butane tetracarboxylic acid, 1,2,2,6,6-pentamethyl-4-piperidinol and β,β,β′,β′-tetramethyl-3,9-[2,4,8,10-tetraoxaspiro(5,5)undecane]diethanol. The hindered amine type light stabilizers are preferably bis(2,2,6,6-tetramethyl-4-piperidyl)sebacate, bis(N-methyl-2,2,6,6-tetramethyl-4-piperidinyl)sebacate, and a condensate of 1,2,3,4-butane tetracarboxylic acid, 1,2,2,6,6-pentamethyl-4-piperidinol and β,β,β′,β′-tetramethyl-3,9-[2,4,8,10-tetraoxaspiro(5,5)undecane]diethanol. These hindered amine type light stabilizers are used singly or in combinations of two or more.

### (Mold Release Agent)

As the mold release agent, an alcohol, a fatty acid and a fatty acid ester thereof, polyoxyalkylene glycol, and an olefin compound having a degree of average polymerization of 10 to 500 are preferably used.

Preferably, the polyacetal resin composition of the present embodiment further contains an aliphatic alcohol and/or an ester being formed from a fatty acid and an aliphatic alcohol. In the polyacetal resin composition of the present embodiment, the contents of the above aliphatic alcohol and/or ester are preferably 0.1 to 10 parts by mass, more preferably 0.5 to 7 parts by mass, and still more preferably 1 to 5 parts by mass, based on 100 parts by mass of the polyacetal resin (A). The polyacetal resin composition which contains the aliphatic alcohol and/or the ester being formed from the fatty acid and the aliphatic alcohol, within the above range tends to have further improved mold release characteristics.

### (Others)

The polyacetal resin composition of the present embodiment may further contain known additives as needed without damaging the object achievement of the present invention. Specific examples thereof include crystal nucleating agents, electroconductive materials, thermoplastic resins, thermoplastic elastomers, pigments, and waxes.

Examples of the crystal nucleating agents include, but are not particularly limited to, boron nitride.

Examples of the electroconductive materials include, but are not particularly limited to, carbon fibers, artificial or natural graphites, single-walled or multi-walled carbon nanotubes, metal powders, and metal fibers. However, the electroconductive materials described herein exclude the above electroconductive carbon black (B).

Examples of the thermoplastic resins include, but are not particularly limited to, olefin resins, acrylic resins, styrene resins, polycarbonate resins, and uncured epoxy resins. Modified products of these resins may be used as the thermoplastic resin. Particularly preferably, the polyacetal resin composition of the present embodiment further contains the olefin resin. In the polyacetal resin composition of the present embodiment, the content of the olefin resin is preferably 0.5 to 20 parts by mass, more preferably 1 to 17 parts by mass, and still more preferably 2 to 15 parts by mass, based on 100 parts by mass of the polyacetal resin (A). The polyacetal resin composition containing the olefin resin within the above range has a small change in electroconductivity before and after a sliding test, which is preferable.

Examples of the thermoplastic elastomers include, but are not particularly limited to, polyurethane elastomers, polyester elastomers, polystyrene elastomers, and polyamide elastomers.

Examples of the pigments include, but are not particularly limited to, inorganic pigments, organic pigments, metallic pigments, and fluorescent pigments. The inorganic pigments as used herein mean those ordinarily used for coloring of resins. Examples thereof include, but are not particularly limited to, zinc sulfide, titanium oxide, barium sulfate, titanium yellow, cobalt blue, calcined pigments, carbonates, phosphates, acetates, acetylene black, and lamp black. Examples of the organic pigments include, but are not particularly limited to, condensed azo pigments, quinoline pigments, phthalocyanine pigments, monoazo pigments, diazo pigments, polyazo pigments, anthraquinone pigments, heterocyclic pigments, perinone pigments, quinacridone pigments, thioindigo pigments, perylene pigments, dioxazine pigments, and phthalocyanine pigments.

The ratio of the pigment added to the polyacetal resin composition of the present embodiment is significantly changed according to the required color tone, which makes it difficult to clearly define the ratio. Generally, the pigment is preferably used in the range of 0.05 to 5 parts by mass based on 100 parts by mass of the polyacetal resin (A).

Preferably, the polyacetal resin composition of the present embodiment further contains one or more selected from the group consisting of a polyolefin wax, a paraffin wax, a carnauba wax, and a polyamide wax. In the polyacetal resin composition of the present embodiment, the content of the wax is preferably 0.01 to 5 parts by mass, more preferably 0.1 to 4 parts by mass, and still more preferably 0.3 to 3 parts by mass, based on 100 parts by mass of the polyacetal resin (A). The polyacetal resin composition containing these waxes within the above range has a small change in electroconductivity before and after a sliding test, which is preferable.

### <<Method for Producing Polyacetal Resin Composition>>

Next, a preferable method for producing the polyacetal resin composition of the present embodiment will be described. In some cases, the polyacetal resin (A), the electroconductive carbon black (B), and the epoxy compound (C) are merely written as a component (A), a component (B), and a component (C) respectively in order to simplify the description herein.

Kneading machines generally used can be applied as an apparatus for producing the polyacetal resin composition of the present embodiment. Examples thereof include a single-screw or multi-screw extruder, a roll, and a Banbury mixer. Among them, a twin-screw extruder equipped with a pressure reducing device and a side feeder equipment is preferable.

The polyacetal resin composition of the present embodiment can be obtained by melting and kneading the component (A), the component (B), and the component (C) and other components as needed using an extruder, for example.

Examples of a method for melting and kneading the components using the extruder include, but are not particularly limited to, a method for supplying all components from a top feeder of an extruder (hereinafter, also written as “a top feeder”) to melt and knead the components, a method for supplying all or part of the components other than the component (B) from the top feeder, and supplying the remaining components and the component (B) from a side feeder located in the middle of the extruder to melt and knead the components, and a method for supplying the whole or part of the component (A) from the top feeder, and supplying the remainder of the component (A), the component (B), and the component (C) from the side feeder to melt and knead the components. The components can be supplied from one side feeder or a plurality of different side feeders.

From the viewpoint of achieving the object of the present invention, among the above methods, the method for supplying a part of the components other than the component (B) from the top feeder, and supplying the remaining components and the components (B) from the same side feeder to melt and knead the components is preferable. Herein, the amount of the component (A) added simultaneously with the component (B) is preferably 10% by mass or more and 90% by mass or less, more preferably 15% by mass or more and 80% by mass or less, and still more preferably 20% by mass or more and 70% by mass or less, based on the whole amount of the component (A) contained in the polyacetal resin composition. When the component (B) is supplied, the component (A) supplied from the top feeder is more preferably in a melt state in the extruder.

The component (B) may be independently supplied. However, a master batch in which the component (B) is previously dispersed in the component (A) is preferably supplied. The content ratio of the component (B) in the master batch is preferably in the range of 1.5 to 3 times the content ratio of the component (B) in the intended polyacetal resin composition.

Hereinafter, the melting and kneading using the extruder will be described. Various conditions in the melting and kneading are particularly selected from the viewpoints of moderately controlling the dispersibility of the electroconductive carbon black (B), and sufficiently removing a volatile gas generated during melting and kneading.

### (Operating Condition)

The temperature for melting and kneading is preferably a temperature higher by 1 to 100° C. than the melting point of the polyacetal resin (A) to be used. More specifically, the temperature for melting and kneading is preferably 160° C. to 240° C. The melting point of the polyacetal resin (A) can be obtained by differential scanning calorimetry (DSC) according to JIS K7121. The rotation number of a screw in the kneading machine is preferably 100 rpm or more, and an average residence time during kneading is preferably 30 seconds to 1 minute.

### (Screw Design of Extruder)

The screw design of the extruder is not particularly limited as long as each component is in a perfect melt state when a resin is discharged from a discharge port of the extruder. A kneading zone including one or more kneading screws and/or a backward flight is preferably provided in each of at least two positions. When the component (B) is supplied from the side feeder, a plurality of kneading zones are preferably provided. It is preferable that the upstream side kneading zone of the kneading zones is provided on the upstream side of the side feeder for supplying the component (B) or the like, and the downstream side kneading zone is provided on the downstream side of the side feeder provided on the lowermost downstream side. It is more preferable that the upstream side kneading zone does not include a backward kneading screw or a backward flight.

### (Vent)

The extruder is provided with a deaerating apparatus, and thereby the volatile gas generated during melting and kneading can be efficiently exhausted. Examples of the deaerating method include a method for opening the inside of an extruder to the atmosphere using a vent port provided in the extruder, a method for vacuum-deaerating the inside of an extruder from a vent port, a method for providing another side feeder in addition to a side feeder for supplying the component (B) or the like. These methods can be appropriately used in combination.

A site in which the vent port is provided can be appropriately selected. However, from the viewpoint of stably producing the polyacetal resin composition of the present embodiment, at least one vent port is preferably provided on the upstream and downstream sides of the side feeder for supplying the component (B) or the like. Herein, the above upstream side vent port is preferably an atmospheric release type. On the other hand, the downstream side vent port is preferably a vacuum deaerating type or the side feeder is preferably provided in the downstream side vent port. When the side feeder is provided, a vacuum deaerating type vent port is more preferably provided on the further downstream side.

A degree of pressure reduction during vacuum deaerating is preferably, but not particularly limited to, 0 to 0.07 MPa.

When the side feeder is provided, a screw in the side feeder may be operated or may not be operated. An additive or the like may be blended from the side feeder. Only the screw may be operated without blending anything.

### <<Molded Product>>

The molded product of the present embodiment contains the above polyacetal resin composition.

The molded product of the present embodiment is a molded product which contains a polyacetal resin composition having excellent dimensional accuracy and capable of maintaining an initial electroconductive level even after being slid for a long period. The molded product of the present embodiment can be integrated with other materials (metal or the like) by “excellent dimensional accuracy.” A part including the molded product of the present embodiment can be easily designed by “capable of maintaining an initial electroconductive level even after being slid for a long period.”

When the electroconductive level after being slid for a long period is significantly decreased as compared with the initial electroconductive level, it is necessary to perform design allowing for decrease in the electroconductive level (overspecification in view of the initial electroconductive level) when a part is designed. However, since the molded product of the present embodiment maintains the initial electroconductive level, it is not necessary to perform design as deemed overspecification.

Further, when design as deemed overspecification as compared with the electroconductivity as the design target is required, the electroconductivity of the molded product may be too higher than the design target in the initial use, which may cause failure of OA equipment in which an electroconductive member containing the present composition is incorporated.

The molded product of the present embodiment can be obtained by molding the above polyacetal resin composition, for example. The method for molding the above polyacetal resin composition to produce the molded product is not particularly limited as long as the method is the same as the conventional method for molding the polyacetal resin composition. Examples thereof include extrusion, injection molding, vacuum forming, blow molding, injection compression molding, decorative molding, multi-material molding, gas assist injection molding, foam injection molding, low pressure molding, ultra thin wall injection molding (ultra-high-speed injection molding), and in-mold composite molding (insert molding and outsert molding).

Since the molded product obtained from the above polyacetal resin composition by the molding method, for example, an injection molding obtained by injection molding can have a complicated shape, the molded product can be used as molded articles for various applications. Examples of the molded articles include, but are not particularly limited to, structural parts typified by gears, cams, sliders, levers, arms, clutches, felt clutches, idler gears, pulleys, rollers, rolls, key stems, key tops, shutters, reels, shafts, joints, axles, bearings, and guides; resin parts obtained by outsert molding; resin parts obtained by insert molding; chassis, trays, side plates, and mechanism parts for office automation equipment typified by printers and copying machines; parts for cameras and video devices typified by a VTR (video tape recorder), video camcorders, digital video cameras, cameras, and digital cameras; music, image, and information devices typified by cassette players, a DAT, an LD (laser disk), an MD (mini disk), a CD (compact disk) [including CD-ROM (read only memory), CD-R (recordable), and CD-RW (rewritable)], a DVD (digital video disk) [including DVD-ROM, DVD-R, DVD+R, DVD-RW, DVD+RW, DVD-R DL, DVD+R DL, DVD-RAM (random access memory), and DVD-Audio], a Blu-ray disc, an HD-DVD, other optical disc drives, an MFD, an MO, navigation system, and mobile personal computers; parts for communications apparatuses typified by mobile phones and facsimiles; parts for electrical devices; and parts for electronic devices.

The molded product of the present embodiment can also be used as automotive parts or the like. Examples of the automotive parts include, but are not limited to, fuel system parts typified by gas tanks, fuel pump modules, valves, and gas tank flanges; door-related parts typified by door locks, door handles, window regulators, and speaker grills; seat belt-related parts typified by slip rings for a seat belt and press buttons; and combination switch parts, parts for switches, and parts for clips. The molded product of the present embodiment is preferably used as the pen tip or lead of a mechanical pencil and structural parts for fitting or removing the lead of a mechanical pencil, washbasins, and structural parts for opening and closing drainage outlets and waste plugs, parts for opening and closing section locking mechanism and commodity discharging mechanism of automatic vending machine, cord stoppers, adjusters and buttons for clothing, water spray nozzles and water spray hose joints, construction parts such as handrails at staircase and flooring supports, and industrial parts typified by disposable cameras, toys, zippers, chains, conveyors, buckles, sporting goods, automatic vending machines, furniture, musical instruments, and housing equipment.

Although the embodiment for implementing the present invention has been described above, the present invention is not limited to the above present embodiments. The present invention can be modified variously without departing from the scope thereof.

### EXAMPLES

Hereinafter, the present invention will be more specifically described by Examples and Comparative Examples. However, the present invention is in no way limited to Examples.

The following components were used for the present Examples.

### [Polyacetal Resin (A)]

### (A-1)

A self-cleaning type twin-screw polymerizer (L/D=8) equipped with a jacket and permitting passage of a heat medium was adjusted to a temperature of 80° C. Trioxane was successively added at 4 kg/hr to the polymerizer. 1,3-dioxolane as a comonomer was successively added at 128.3 g/h (3.9 mol % per mol of trioxane). Methylal as a chain transfer agent was successively added in an amount adjusted so that the melt flow rate of a polyacetal resin to be obtained was 30 g/10 min. Further, boron trifluoride di-n-butyl etherate as a polymerization catalyst was successively added in an amount of 1.5×10⁻⁵ mol per mol of trioxane to perform polymerization. A polyacetal copolymer discharged from the polymerizer was put into a 0.1% by mass aqueous solution of triethylamine to deactivate the polymerization catalyst. The polyacetal copolymer after deactivation of the polymerization catalyst was filtered by using a centrifugal separator, to fractionate the polyacetal copolymer. To 100 parts by mass of the fractionated polyacetal copolymer, 1 part by mass of an aqueous solution containing, as a quaternary ammonium compound, choline hydroxide formate (triethyl-2-hydroxyethylammonium formate) was added, and followed by uniform mixing, to obtain a mixed aqueous solution. The mixed aqueous solution was dried at 120° C. An amount of the choline hydroxide formate to be added was adjusted by the concentration of the choline hydroxide formate in the aqueous solution containing the choline hydroxide formate to be added. The choline hydroxide formate was added in an amount of 20 ppm by mass in terms of nitrogen. The polyacetal copolymer after drying was supplied to a twin-screw extruder equipped with a vent and 0.5 parts by mass of water was added to 100 parts by mass of the polyacetal copolymer melted in the extruder. An unstable terminal portion was decomposed and removed by melting and kneading for a residence time of 7 minutes in the extruder while setting the temperature of the extruder to 200° C. The polyacetal copolymer which the unstable terminal portion had been decomposed in and removed from was degassed under a condition of a degree of vent vacuum of 20 Torr, extruded from the dice portion of the extruder as a strand, and pelletized, to obtain a polyacetal resin. To 100 parts by mass of the polyacetal resin thus obtained, 0.3 parts by mass of triethylene glycol-bis-[3-(3-t-butyl-5-methyl-4-hydroxyphenyl)-propionate] as an antioxidant was added. These were melted and kneaded in the twin-screw extruder equipped with a vent, to produce pellets of a polyacetal resin (A-1).

### (A-2)

Pellets of a polyacetal resin (A-2) were obtained in the same manner as that employed for the production of the polyacetal resin (A-1) except that the amount of methylal as a chain transfer agent was adjusted so that the melt flow rate of the polyacetal resin to be obtained was 45 g/10 min in the above production method of the polyacetal resin (A-1).

### (A-3)

A self-cleaning type twin-screw polymerizer (L/D=8) equipped with a jacket and permitting passage of a heat medium was adjusted to a temperature of 80° C. Trioxane was successively added at 4 kg/hr to the polymerizer. 1,3-dioxolane as a comonomer was successively added at 128.3 g/h (3.9 mol % per mol of trioxane). Methylal as a chain transfer agent was successively added in an amount adjusted so that the melt flow rate of a polyacetal resin to be obtained was 30 g/10 min. Further, boron trifluoride di-n-butyl etherate as a polymerization catalyst was successively added in an amount of 2.0×10⁻⁵ mol per mol of trioxane to perform polymerization. A polyacetal copolymer discharged from the polymerizer was put into a 0.1% by mass aqueous solution of triethylamine to deactivate the polymerization catalyst. The polyacetal copolymer after deactivation of the polymerization catalyst was filtered by using a centrifugal separator, to fractionate the polyacetal copolymer. To 100 parts by mass of the fractionated polyacetal copolymer, 1 part by mass of an aqueous solution containing 2% by mass of triethylamine was added, and followed by uniform mixing, to obtain a mixed aqueous solution. The mixed aqueous solution was dried at 120° C. The polyacetal copolymer after drying was supplied to a twin-screw extruder equipped with a vent and 0.5 parts by mass of water was added to 100 parts by mass of the polyacetal copolymer melted in the extruder. An unstable terminal portion was decomposed and removed by melting and kneading for a residence time of 7 minutes in the extruder while setting the temperature of the extruder to 200° C. The polyacetal copolymer which the unstable terminal portion had been decomposed in and removed from was degassed under a condition of a degree of vent vacuum of 20 Torr, extruded from the dice portion of the extruder as a strand, and pelletized, to obtain a polyacetal resin. 0.3 parts by mass of melamine was added to 100 parts by mass of the polyacetal resin thus obtained. These were melted and kneaded in a twin-screw extruder equipped with a vent, to produce pellets of a polyacetal resin (A-3).

### [Electroconductive Carbon Black (B)]

(B-1) carbon black having an amount of DBP oil absorption of 420 mL/100 g and a BET specific surface area of 1000 m²/g

(B-2) carbon black having an amount of DBP oil absorption of 385 mL/100 g and a BET specific surface area of 800 m²/g

(B-3) carbon black having an amount of DBP oil absorption of 180 mL/100 g and a BET specific surface area of 51 m²/g

(B-4) carbon black having an amount of DBP oil absorption of 76 mL/100 g and a BET specific surface area of 85 m²/g

In the present Examples, the amount of DBP oil absorption was measured according to ASTM D2415-65T, and the BET specific surface area was measured by a nitrogen adsorption method.

### [Epoxy Compound (C) and Curing Accelerator for Epoxy Compound (C)]

A condensate of cresol novolac and epichlorohydrin (ECN-1299 manufactured by Asahi Kasei E-materials Corporation) was used as the epoxy compound (C). Triphenyl phosphine (described also as “TPP” hereinafter manufactured by Hokko Chemical Industry Co., Ltd.) was used as the curing accelerator for the epoxy compound (C).

### [Other Components]

### [Aliphatic Alcohol]

Behenyl alcohol was used as the aliphatic alcohol.

### [Olefin Resin]

As the olefin resin, an olefin copolymer having a 1-butene content of 90% by mass and an ethylene content of 10% by mass was used. The MFR of the olefin copolymer based on JIS K7210 (conditions of 190° C. and 2.16 kg) was 40 g/10 min.

### [Wax]

Ethylenebisstearylamide (polyamide wax) was used as the wax.

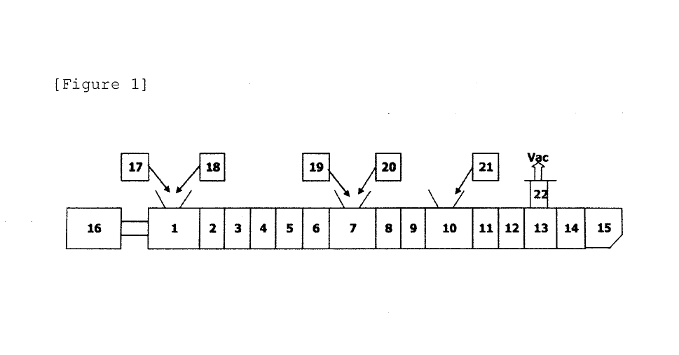

### (Description of Extruder (FIG. 1))

In the present Examples, a polyacetal resin composition was produced by using a twin-screw extruder (a TEM-48SS extruder (L/D=58.4, with a vent) manufactured by. Toshiba Machine Co., Ltd.). The diameter of a main screw of the twin-screw extruder was 48 mm. The schematic view of the extruder is shown in FIG. 1.

### (Method for Producing Polyacetal Resin Composition)

### <Production Method I>

In the twin-screw extruder shown in FIG. 1, no side feeder was provided and a barrel zone 1 was cooled with cooling water. Barrel zones 2 to 6 were set at 220° C.; barrel zones 7 to 14 were set at 190° C.; and a die head 15 was set at 210° C. To the twin-screw extruder, a mixture (hereinafter, the mixture is also described as a “mixture M”) containing the polyacetal resin (A), and the epoxy compound (C) and a curing accelerator (triphenyl phosphine) for the epoxy compound (C) as needed was supplied in a solid phase state by a constant feeder 17. The electroconductive carbon black (B) was supplied by a constant feeder 18. These were melted and kneaded under conditions where the rotation number of a screw of an extruder motor 16 was 300 rpm and an amount of extrusion was 200 kg/h, to obtain a kneaded product. Deaeration was performed from a deaerating vent 22 by using a vacuum pump. The obtained kneaded product was solidified in a strand bath, and then pelletized, to produce pellets of a polyacetal resin composition.

### <Production Method II>

Pellets of a polyacetal resin composition were produced in the same manner as in the production method I except that a side feeder 1 (constant feeder 19) was installed in one position of a barrel zone 7 in a twin-screw extruder; the screw of the side feeder 1 was merely rotated at 50 rpm; and nothing was supplied from the side feeder 1.

### <Production Method III>

Pellets of a polyacetal resin composition were produced in the same manner as in the production method I except that a side feeder 1 (constant feeder 19) was installed in one position of a barrel zone 7 in a twin-screw extruder; the screw of the side feeder 1 was rotated at 350 rpm; and the position of the electroconductive carbon black (B) to be supplied was set to the constant feeder 19.

### <Production Method IV>

Pellets of a polyacetal resin composition were produced in the same manner as in the production method III except that a side feeder 1 (constant feeder 19) and a side feeder 3 (constant feeder 21) were installed in two positions, a barrel zone 7 and a barrel zone 10, respectively, in a twin-screw extruder; the screw of the side feeder 1 installed in the barrel zone 7 was rotated at 50 rpm; the screw of the side feeder 3 installed in the barrel zone 10 was rotated at 350 rpm; nothing was supplied from the side feeder 1; and the position of the electroconductive carbon black (B) to be supplied was set to the side feeder 3.

### <Production Method V>

Pellets of a polyacetal resin composition were produced in the same manner as in the production method IV except that in a twin-screw extruder, the screw of a side feeder 1 (constant feeder 19) was rotated at 350 rpm; the screw of a side feeder 3 (constant feeder 21) was rotated at 50 rpm; nothing was supplied from the side feeder 3; and the position of the electroconductive carbon black (B) to be supplied was set to the side feeder 1.

### <Production Method VI>

Pellets of a polyacetal resin composition were produced in the same manner as in the production method V except that the position of a mixture M to be supplied was set to two positions, a constant feeder 17 (top feeder 1) and a constant feeder 20 (side feeder 2) in a twin-screw extruder; and the ratio (mass) of the mixture M to be supplied from the constant feeders 17 and 20 was set to 95:5 (constant feeder 17:constant feeder 20).

### <Production Method VII>

Pellets of a polyacetal resin composition were produced in the same manner as in the production method VI except that the ratio (mass) of a mixture M to be supplied from constant feeders 17 and 20 was set to 70:30 (constant feeder 17:constant feeder 20).

### <Production Method VIII>

Pellets of a polyacetal resin composition were produced in the same manner as in the production method VII except that a vent port 22 was an atmospheric release type in a twin-screw extruder.

### <Production Method IX>

Pellets of a polyacetal resin composition were produced in the same manner as in the production method VII except that the screw of a side feeder 3 (constant feeder 21) was not rotated in a twin-screw extruder.

### <Production Method X>

First, master batch pellets (hereinafter, written also as “CB-MB”) of a polyacetal resin and carbon black in which the concentration of carbon black was 2 times the intended concentration in a polyacetal resin composition were produced by the production method VII. Then, a mixture M was supplied to the twin-screw extruder from a constant feeder 17. The CB-MB was supplied from a constant feeder 18, and melted and kneaded under conditions where the rotation number of a screw of an extruder motor 16 was 300 rpm and an amount of extrusion was 200 kg/h, to obtain a kneaded product. Deaeration was performed from a deaerating vent 22 by using a vacuum pump. The obtained kneaded product was solidified in a strand bath, and then pelletized, to produce pellets of a polyacetal resin composition.

### (Method for Measuring Melt Flow Rate (MFR))

The melt flow rate (MFR) of the polyacetal resin composition was measured according to JIS K 7210 under conditions of a test temperature of 190° C. and a test load of 2.16 kg.

### (Method for Measuring Melt Viscosity)

A ratio V₁/V₂ of a melt viscosity V₁ measured under conditions of 210° C. and a shear rate of 100 s⁻¹ to a melt viscosity V₂ measured under conditions of 210° C. and a shear rate of 1000 s⁻¹ was obtained according to JIS K 7199.

(Method for Measuring Volume Resistivity Before and after Sliding Test)

A polyacetal resin composition was molded under injection conditions of a cylinder temperature set to 205° C., mold temperature set to 90° C., injection time of 35 seconds, and cool time of 15 seconds by using an EC-75NII molding machine manufactured by Toshiba Machine Co., Ltd., to obtain an ISO dumbbell. The dumbbell was then cut into a flat plate of 30×20×4 mm. The flat plate was used as a sample for volume resistivity measurement. A volume resistivity before and after a sliding test was measured as follows according to JIS K 7194 by using the sample for volume resistivity measurement.

Loresta GP manufactured by Mitsubishi Chemical Corporation was used to measure the volume resistivity (electroconductivity). The volume resistivity of the sample (flat plate) was measured under a condition of an applied voltage of 90 V by using a 4-pin ASP probe (inter-pin distance: 5 mm, pin point: 0.37 mm R×4, spring pressure: 210 g/piece, JIS K7194 compliant) as a probe. The measured value was defined as “a volume resistivity before a sliding test.”

In the above manner, the volume resistivity of the sample (flat plate) was measured, and the sample (flat plate) was then set in a reciprocal frictional wear test apparatus (AFT-15MS type manufactured by Toyo Seimitsu K.K.), to perform a reciprocation test 10000 times at an environmental temperature of 23° C. by using a SUS ball (SUS304, diameter: 2.5 mm) as a counter material under conditions of a load of 2 kg, linear velocity of 30 mm/sec, and reciprocation distance of 20 mm. After the reciprocation test, the volume resistivity of the sample (flat plate) was measured in the same way as above in a state where the 4-pin probe was brought into contact with a sliding dint section formed in the sample (flat plate). The measured value was defined as “a volume resistivity after a sliding test.”

### (Moldability Test)

The moldability test of the polyacetal resin composition was performed as follows.

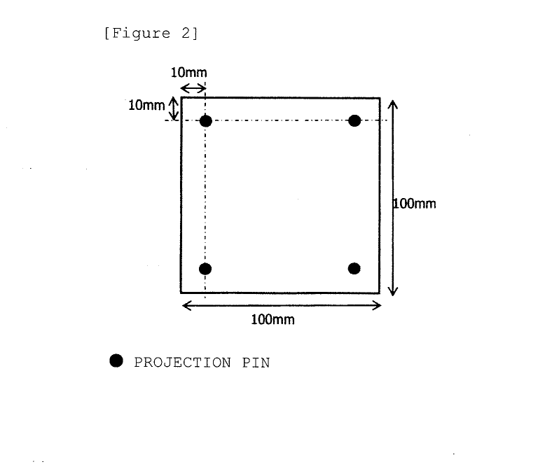

A flat plate of 100×100×1.5 mm was continuously subjected to 100 shots of molding from the polyacetal resin composition under injection conditions of an injection time of 15 seconds and cool time of 10 seconds at a cylinder temperature set to 200° C. and a mold temperature set to 70° C. by using an IS-100GN injection molding machine manufactured by Toshiba Machine Co., Ltd. An injection pressure was adjusted depending on the polyacetal resin composition to be molded, and the above mold was filled with the polyacetal resin composition. In this case, the projection velocity of a projection pin from the mold was set to 500 mm/sec. In the moldability test, the number of the molded pieces in which deficiencies such as flaws, cracks, and chips were not generated in the molded piece (flat plate) among 100 shots was counted. The increased number of the molded pieces in which the deficiencies were not generated was determined to provide more excellent moldability. The positions of the projection pins were as shown in FIG. 2.

### (Method for Measuring Dimensional Accuracy)

A helical gear having a right helical direction, pitch circle diameter of 80 mm, a module 1, a helical angle of 20 degrees, a face width of 12 mm, a web thickness of 2 mm, and 12 ribs was produced by molding a polyacetal resin composition under conditions of a cylinder temperature of 200° C. and mold temperature of 80° C. by using an injection molding machine (trade name “SH-75”) manufactured by Sumitomo Heavy Industries, Ltd. In the helical gear thus obtained, a tooth form error and a tooth trace error in four gear teeth provided at intervals of 90 degrees were measured according to JIS B 1702-1 by using a gear accuracy measuring instrument manufactured by Osaka Seimitsu Kikai Co., Ltd. The decreased numerical values (μm) of the tooth form error and tooth trace error were determined to provide the helical gear having more excellent accuracy.

### (Amount of Residue)

An amount of residue (weight after incineration/weight before incineration×100) when the polyacetal resin composition was incinerated for 1 hour under conditions of an air atmosphere and 500° C. was measured.

### Examples 1 to 37

Components were blended at ratios of amounts shown in Tables 1 and 2, to produce pellets of a polyacetal resin composition by production methods shown in Tables 1 and 2. The physical properties of the obtained pellets were evaluated by the above methods. The results are shown in Tables 3 and 4.

### Comparative Examples 1 to 32

Components were blended at ratios of amounts shown in Tables 5 and 6, to produce pellets of a polyacetal resin composition by production methods shown in Tables 5 and 6. The physical properties of the obtained pellets were evaluated by the above methods. The results are shown in Tables 7 and 8.

TABLE 1

| | | | | | (C) | Curing | | | | |
|---|---|---|---|---|---|---|---|---|---|---|
| | (A) | | (B) Electroconductive | | Epoxy | accelerator | Aliphatic | Olefin | | |
| | Polyacetal resin | | carbon black | | compound | (TPP) | alcohol | resin | Wax | Production |
| | Type | part by mass | Type | part by mass | part by mass | part by mass | part by mass | part by mass | part by mass | method |
| Example 1 | A-1 | 100 | B-1 | 7 | 2 | 1 | — | — | — | VI |
| Example 2 | A-2 | 100 | B-1 | 7 | 2 | 1 | — | — | — | VI |
| Example 3 | A-1 | 100 | B-2 | 7 | 2 | 1 | — | — | — | VI |
| Example 4 | A-1 | 100 | B-2 | 7 | 2 | 1 | — | — | — | VII |
| Example 5 | A-1 | 100 | B-2 | 7 | 2 | 1 | — | — | — | IX |
| Example 6 | A-1 | 100 | B-2 | 10 | 2 | 1 | — | — | — | VII |
| Example 7 | A-1 | 100 | B-2 | 10 | 2 | 1 | — | — | — | IX |
| Example 8 | A-2 | 100 | B-2 | 7 | 2 | 1 | — | — | — | VI |
| Example 9 | A-1 | 100 | B-3 | 20 | 2 | 1 | — | — | — | I |
| Example 10 | A-1 | 100 | B-3 | 20 | 2 | 1 | — | — | — | II |
| Example 11 | A-1 | 100 | B-3 | 20 | 2 | 1 | — | — | — | III |
| Example 12 | A-1 | 100 | B-3 | 20 | 2 | 1 | — | — | — | IV |
| Example 13 | A-1 | 100 | B-3 | 20 | 2 | 1 | — | — | — | V |
| Example 14 | A-1 | 100 | B-3 | 20 | 2 | 1 | — | — | — | VI |
| Example 15 | A-1 | 100 | B-3 | 20 | 2 | 1 | — | — | — | VII |
| Example 16 | A-1 | 101 | B-3 | 20 | 2 | 1 | 3 | — | — | VII |
| Example 17 | A-1 | 102 | B-3 | 20 | 2 | 1 | — | 10 | — | VII |
| Example 18 | A-1 | 103 | B-3 | 20 | 2 | 1 | — | — | 1 | VII |

TABLE 2

| | | | | | (C) | Curing | | | | |
|---|---|---|---|---|---|---|---|---|---|---|
| | (A) | | (B) Electroconductive | | Epoxy | accelerator | Aliphatic | Olefin | | |
| | Polyacetal resin | | carbon black | | compound | (TPP) | alcohol | resin | Wax | Production |
| | Type | part by mass | Type | part by mass | part by mass | part by mass | part by mass | part by mass | part by mass | method |
| Example 19 | A-1 | 100 | B-3 | 20 | 2 | 1 | — | — | — | VIII |
| Example 20 | A-1 | 100 | B-3 | 20 | 2 | 1 | — | — | — | IX |
| Example 21 | A-1 | 100 | B-3 | 20 | 2 | 1 | — | — | — | X |
| Example 22 | A-2 | 100 | B-3 | 20 | 2 | 1 | — | — | — | III |
| Example 23 | A-2 | 100 | B-3 | 25 | 2 | 1 | — | — | — | I |
| Example 24 | A-2 | 100 | B-3 | 25 | 2 | 1 | — | — | — | II |
| Example 25 | A-2 | 100 | B-3 | 25 | 2 | 1 | — | — | — | III |
| Example 26 | A-2 | 100 | B-3 | 25 | 2 | 1 | — | — | — | IV |
| Example 27 | A-2 | 100 | B-3 | 25 | 2 | 1 | — | — | — | V |
| Example 28 | A-2 | 100 | B-3 | 25 | 2 | 1 | — | — | — | VI |
| Example 29 | A-2 | 100 | B-3 | 25 | 2 | 1 | — | — | — | VII |
| Example 30 | A-2 | 100 | B-3 | 25 | 2 | 1 | — | — | — | VIII |
| Example 31 | A-2 | 100 | B-3 | 25 | 2 | 1 | — | — | — | IX |
| Example 32 | A-2 | 100 | B-3 | 25 | — | — | — | — | — | IX |
| Example 33 | A-2 | 100 | B-3 | 25 | 2 | 1 | — | — | — | X |
| Example 34 | A-3 | 100 | B-3 | 20 | 2 | 1 | — | — | — | VII |
| Example 35 | A-1 | 100 | B-4 | 25 | 2 | 1 | — | — | — | III |
| Example 36 | A-2 | 100 | B-4 | 25 | 2 | 1 | — | — | — | III |
| Example 37 | A-2 | 100 | B-4 | 30 | 2 | 1 | — | — | — | III |

TABLE 3

| | | | | | | | | Evaluation of | |
|---|---|---|---|---|---|---|---|---|---|
| | | | Volume resistivity | | | Amount of residue | | gear accuracy | |
| | | | Before | After | Ratio of volume | after incineration | Moldability test | Tooth | Tooth |
| | | Melt viscosity | sliding | sliding | resistivity | under conditions of | Number with no | form | trace |
| | MFR | ratio | test | test | (After sliding test)/ | 500° C. and 1 hour | deficiency | error | error |
| | g/10 min | V₁/V₂ | Ω · cm | Ω · cm | (Before sliding test) | wt % | pieces/100 pieces | μm | μm |
| Example 1 | 14 | 2.8 | 24 | 30 | 1.3 | 6.7 | 92 | 40 | 87 |
| Example 2 | 18 | 2.1 | 19 | 25 | 1.3 | 6.6 | 78 | 37 | 75 |
| Example 3 | 15 | 1.9 | 32 | 42 | 1.3 | 6.6 | 95 | 42 | 87 |
| Example 4 | 16 | 1.9 | 32 | 41 | 1.3 | 6.5 | 97 | 39 | 82 |
| Example 5 | 17 | 2.0 | 30 | 40 | 1.3 | 6.3 | 97 | 40 | 80 |
| Example 6 | 8 | 2.9 | 7.3 | 29 | 4.0 | 9.1 | 75 | 85 | 190 |
| Example 7 | 9 | 3.1 | 7.2 | 28 | 3.9 | 9.0 | 80 | 84 | 170 |
| Example 8 | 17 | 1.9 | 20 | 39 | 2.0 | 6.7 | 90 | 38 | 77 |
| Example 9 | 8 | 2.5 | 35 | 69 | 2.0 | 16.7 | 85 | 22 | 57 |
| Example 10 | 9 | 2.6 | 30 | 57 | 1.9 | 16.5 | 88 | 19 | 51 |
| Example 11 | 11 | 2.4 | 26 | 50 | 1.9 | 15.9 | 91 | 17 | 48 |
| Example 12 | 12 | 2.0 | 23 | 42 | 1.8 | 16.2 | 92 | 13 | 42 |
| Example 13 | 9 | 2.5 | 31 | 59 | 1.9 | 16.4 | 88 | 20 | 50 |
| Example 14 | 12 | 1.8 | 24 | 43 | 1.8 | 16.6 | 91 | 14 | 41 |
| Example 15 | 13 | 1.8 | 22 | 40 | 1.8 | 16.5 | 94 | 12 | 38 |
| Example 16 | 12 | 1.7 | 25 | 39 | 1.6 | 16.0 | 94 | 11 | 38 |
| Example 17 | 13 | 1.8 | 27 | 43 | 1.6 | 14.8 | 97 | 10 | 34 |
| Example 18 | 12 | 1.8 | 22 | 37 | 1.7 | 16.3 | 95 | 12 | 35 |

TABLE 4

| | | | | | | | | Evaluation | |
|---|---|---|---|---|---|---|---|---|---|
| | | | Volume resistivity | | | Amount of residue | | of gear accuracy | |
| | | Melt | Before | After | Ratio of volume | after incineration | Moldability test | Tooth | Tooth |
| | | viscosity | sliding | sliding | resistivity | under conditions of | Number with | form | trace |
| | MFR | ratio | test | test | (After sliding test)/ | 500° C. and 1 hour | no deficiency | error | error |
| | g/10 min | V₁/V₂ | Ω · cm | Ω · cm | (Before sliding test) | wt % | pieces/100 pieces | μm | μm |
| Example 19 | 13 | 1.7 | 21 | 38 | 1.8 | 16.5 | 93 | 13 | 39 |
| Example 20 | 13 | 1.8 | 22 | 41 | 1.9 | 16.0 | 94 | 12 | 37 |
| Example 21 | 13 | 1.8 | 22 | 40 | 1.8 | 16.3 | 94 | 13 | 38 |
| Example 22 | 16 | 1.6 | 21 | 40 | 1.9 | 16.4 | 93 | 15 | 44 |
| Example 23 | 10 | 1.9 | 24 | 44 | 1.8 | 20.0 | 82 | 16 | 50 |
| Example 24 | 11 | 1.9 | 21 | 38 | 1.8 | 19.8 | 85 | 14 | 44 |
| Example 25 | 13 | 1.7 | 18 | 30 | 1.7 | 19.5 | 90 | 12 | 40 |
| Example 26 | 14 | 1.5 | 16 | 26 | 1.6 | 19.7 | 92 | 12 | 38 |
| Example 27 | 12 | 1.6 | 22 | 39 | 1.8 | 19.6 | 86 | 15 | 44 |
| Example 28 | 14 | 1.6 | 17 | 28 | 1.6 | 19.5 | 93 | 13 | 40 |
| Example 29 | 16 | 1.6 | 12 | 19 | 1.6 | 19.8 | 95 | 11 | 36 |
| Example 30 | 16 | 1.5 | 13 | 19 | 1.5 | 19.6 | 96 | 12 | 38 |
| Example 31 | 16 | 1.6 | 12 | 19 | 1.6 | 19.5 | 96 | 11 | 37 |
| Example 32 | 16 | 1.8 | 12 | 19 | 1.6 | 20.2 | 96 | 13 | 39 |
| Example 33 | 16 | 1.6 | 13 | 20 | 1.5 | 19.4 | 95 | 12 | 37 |
| Example 34 | 12 | 1.8 | 25 | 49 | 2.0 | 16.6 | 87 | 16 | 45 |
| Example 35 | 8 | 2.6 | 77 | 150 | 1.9 | 19.4 | 90 | 15 | 43 |
| Example 36 | 10 | 1.5 | 70 | 120 | 1.7 | 19.7 | 80 | 13 | 38 |
| Example 37 | 9 | 1.7 | 55 | 90 | 1.6 | 22.5 | 75 | 11 | 35 |

TABLE 5

| | | | (B) | | | Curing | |
|---|---|---|---|---|---|---|---|
| | (A) Polyacetal | | Electroconductive | | (C) Epoxy | accelerator | |
| | resin | | carbon black | | compound | (TPP) | Production |
| | Type | part by mass | Type | part by mass | part by mass | part by mass | method |
| Comparative | A-1 | 100 | B-1 | 3 | 2 | 1 | III |
| Example 1 | | | | | | | |
| Comparative | A-1 | 100 | B-1 | 7 | 2 | 1 | III |
| Example 2 | | | | | | | |
| Comparative | A-2 | 100 | B-1 | 3 | 2 | 1 | III |
| Example 3 | | | | | | | |
| Comparative | A-2 | 100 | B-1 | 7 | 2 | 1 | III |
| Example 4 | | | | | | | |
| Comparative | A-1 | 100 | B-2 | 7 | 2 | 1 | III |
| Example 5 | | | | | | | |
| Comparative | A-1 | 100 | B-2 | 10 | 2 | 1 | III |
| Example 6 | | | | | | | |
| Comparative | A-1 | 100 | B-2 | 10 | 2 | 1 | VI |
| Example 7 | | | | | | | |
| Comparative | A-1 | 100 | B-2 | 13 | 2 | 1 | III |
| Example 8 | | | | | | | |
| Comparative | A-2 | 100 | B-2 | 13 | 2 | 1 | IX |
| Example 9 | | | | | | | |
| Comparative | A-1 | 100 | B-3 | 25 | 2 | 1 | I |
| Example 10 | | | | | | | |
| Comparative | A-1 | 100 | B-3 | 25 | 2 | 1 | II |
| Example 11 | | | | | | | |
| Comparative | A-1 | 100 | B-3 | 25 | 2 | 1 | III |
| Example 12 | | | | | | | |
| Comparative | A-1 | 100 | B-3 | 25 | 2 | 1 | IV |
| Example 13 | | | | | | | |
| Comparative | A-1 | 100 | B-3 | 25 | 2 | 1 | V |
| Example 14 | | | | | | | |
| Comparative | A-1 | 100 | B-3 | 25 | 2 | 1 | VI |
| Example 15 | | | | | | | |
| Comparative | A-1 | 100 | B-3 | 25 | 2 | 1 | VII |
| Example 16 | | | | | | | |

TABLE 6

| | | | (B) | | | Curing | |
|---|---|---|---|---|---|---|---|
| | (A) Polyacetal | | Electroconductive | | (C) Epoxy | accelerator | |
| | resin | | carbon black | | compound | (TPP) | Production |
| | Type | part by mass | Type | part by mass | part by mass | part by mass | method |
| Comparative | A-1 | 100 | B-3 | 25 | 2 | 1 | VIII |
| Example 17 | | | | | | | |
| Comparative | A-1 | 100 | B-3 | 25 | 2 | 1 | IX |
| Example 18 | | | | | | | |
| Comparative | A-1 | 100 | B-3 | 25 | 2 | 1 | X |
| Example 19 | | | | | | | |
| Comparative | A-2 | 100 | B-3 | 30 | 2 | 1 | I |
| Example 20 | | | | | | | |
| Comparative | A-2 | 100 | B-3 | 30 | 2 | 1 | II |
| Example 21 | | | | | | | |
| Comparative | A-2 | 100 | B-3 | 30 | 2 | 1 | III |
| Example 22 | | | | | | | |
| Comparative | A-2 | 100 | B-3 | 30 | 2 | 1 | IV |
| Example 23 | | | | | | | |
| Comparative | A-2 | 100 | B-3 | 30 | 2 | 1 | V |
| Example 24 | | | | | | | |
| Comparative | A-2 | 100 | B-3 | 30 | 2 | 1 | VI |
| Example 25 | | | | | | | |
| Comparative | A-2 | 100 | B-3 | 30 | 2 | 1 | VII |
| Example 26 | | | | | | | |
| Comparative | A-2 | 100 | B-3 | 30 | 2 | 1 | VIII |
| Example 27 | | | | | | | |
| Comparative | A-2 | 100 | B-3 | 30 | 2 | 1 | IX |
| Example 28 | | | | | | | |
| Comparative | A-2 | 100 | B-3 | 30 | 2 | 1 | X |
| Example 29 | | | | | | | |
| Comparative | A-3 | 100 | B-3 | 25 | 2 | 1 | VII |
| Example 30 | | | | | | | |
| Comparative | A-1 | 100 | B-4 | 30 | 2 | 1 | VII |
| Example 31 | | | | | | | |
| Comparative | A-2 | 100 | B-4 | 35 | 2 | 1 | III |
| Example 32 | | | | | | | |

TABLE 7

| | | | Volume | | | Amount of residue | Moldability test | Evaluation of | |
|---|---|---|---|---|---|---|---|---|---|
| | | | resistivity | | | after incineration | Number | gear accuracy | |
| | | Melt | Before | After | Ratio of volume | under conditions | with no | Tooth | Tooth |
| | | viscosity | sliding | sliding | resistivity | of 500° C. | deficiency | form | trace |
| | MFR | ratio | test | test | (After sliding test)/ | and 1 hour | | error | error |
| | g/10 min | V₁/V₂ | Ω · cm | Ω · cm | (Before sliding test) | wt % | pieces/100 pieces | μm | μm |
| Comparative | 16 | 2.0 | 3.2E+05 | 1.8E+06 | 5.6 | 2.9 | 90 | 25 | 63 |
| Example 1 | | | | | | | | | |
| Comparative | 13 | 2.9 | 120 | 320 | 2.7 | 6.5 | 87 | 80 | 172 |
| Example 2 | | | | | | | | | |
| Comparative | 18 | 1.7 | 2.1E+05 | 9.7E+05 | 4.6 | 2.7 | 80 | 27 | 70 |
| Example 3 | | | | | | | | | |
| Comparative | 15 | 3.4 | 110 | 260 | 2.4 | 6.4 | 45 | 98 | 347 |
| Example 4 | | | | | | | | | |
| Comparative | 14 | 1.9 | 210 | 500 | 2.4 | 6.5 | 89 | 49 | 97 |
| Example 5 | | | | | | | | | |
| Comparative | 3 | 3.3 | 8.5 | 42 | 4.9 | 9.0 | 54 | 91 | 310 |
| Example 6 | | | | | | | | | |
| Comparative | 5 | 3.1 | 7.5 | 35 | 4.7 | 8.9 | 60 | 87 | 253 |
| Example 7 | | | | | | | | | |
| Comparative | 2 | 3.6 | 9.8 | 45 | 4.6 | 11.2 | 28 | 100 | 353 |
| Example 8 | | | | | | | | | |
| Comparative | 6 | 3.2 | 9.0 | 37 | 4.1 | 10.9 | 37 | 90 | 295 |
| Example 9 | | | | | | | | | |
| Comparative | 2 | 3.4 | 8.1 | 35 | 4.3 | 19.5 | 55 | 94 | 307 |
| Example 10 | | | | | | | | | |
| Comparative | 2 | 3.2 | 6.3 | 25 | 4.0 | 19.7 | 57 | 90 | 282 |
| Example 11 | | | | | | | | | |
| Comparative | 3 | 3.2 | 5.6 | 22 | 3.9 | 19.4 | 62 | 87 | 269 |
| Example 12 | | | | | | | | | |
| Comparative | 3 | 3.1 | 5.5 | 20 | 3.6 | 19.2 | 65 | 82 | 240 |
| Example 13 | | | | | | | | | |
| Comparative | 2 | 3.5 | 6.2 | 24 | 3.9 | 19.8 | 55 | 92 | 277 |
| Example 14 | | | | | | | | | |
| Comparative | 4 | 2.8 | 5.7 | 21 | 3.7 | 19.8 | 63 | 82 | 233 |
| Example 15 | | | | | | | | | |
| Comparative | 5 | 2.7 | 5.2 | 18 | 3.5 | 19.4 | 63 | 77 | 209 |
| Example 16 | | | | | | | | | |

TABLE 8

| | | | Volume | | | Amount of residue after | Moldability | Evaluation of | |
|---|---|---|---|---|---|---|---|---|---|
| | | | resistivity | | | incineration under | test | gear accuracy | |
| | | Melt | | | Ratio of volume | conditions | Number | Tooth | Tooth |
| | | viscosity | Before | After | resistivity | of 500° C. and | with no | form | trace |
| | MFR | ratio | sliding test | sliding test | (After sliding test)/ | 1 hour | deficiency | error | error |
| | g/10 min | V₁/V₂ | Ω · cm | Ω · cm | (Before sliding test) | wt % | pieces/100 pieces | μm | μm |
| Comparative | 4 | 2.7 | 5.1 | 19 | 3.7 | 19.5 | 65 | 79 | 218 |
| Example 17 | | | | | | | | | |
| Comparative | 5 | 2.6 | 5.0 | 19 | 3.8 | 19.7 | 64 | 80 | 214 |
| Example 18 | | | | | | | | | |
| Comparative | 5 | 2.7 | 5.2 | 19 | 3.7 | 19.3 | 63 | 79 | 207 |
| Example 19 | | | | | | | | | |
| Comparative | 4 | 2.8 | 7.1 | 26 | 3.7 | 22.5 | 59 | 85 | 247 |
| Example 20 | | | | | | | | | |
| Comparative | 4 | 3.0 | 6.3 | 22 | 3.5 | 22.6 | 60 | 81 | 238 |
| Example 21 | | | | | | | | | |
| Comparative | 5 | 2.7 | 5.0 | 16 | 3.2 | 22.5 | 63 | 79 | 220 |
| Example 22 | | | | | | | | | |
| Comparative | 6 | 2.6 | 4.5 | 14 | 3.1 | 21.9 | 66 | 76 | 209 |
| Example 23 | | | | | | | | | |
| Comparative | 5 | 2.5 | 6.0 | 21 | 3.5 | 22.8 | 59 | 80 | 241 |
| Example 24 | | | | | | | | | |
| Comparative | 5 | 2.6 | 4.7 | 14 | 3.0 | 22.9 | 68 | 78 | 218 |
| Example 25 | | | | | | | | | |
| Comparative | 7 | 2.2 | 4.2 | 12 | 2.9 | 22.1 | 72 | 71 | 188 |
| Example 26 | | | | | | | | | |
| Comparative | 7 | 2.5 | 4.1 | 11 | 2.7 | 22.4 | 70 | 70 | 191 |
| Example 27 | | | | | | | | | |
| Comparative | 7 | 2.3 | 4.0 | 11 | 2.8 | 22.8 | 71 | 72 | 185 |
| Example 28 | | | | | | | | | |
| Comparative | 7 | 2.3 | 4.2 | 11 | 2.6 | 22.6 | 72 | 70 | 187 |
| Example 29 | | | | | | | | | |
| Comparative | 4 | 2.9 | 7.3 | 30 | 4.1 | 19.4 | 57 | 90 | 303 |
| Example 30 | | | | | | | | | |
| Comparative | 4 | 3.0 | 64 | 200 | 3.1 | 22.9 | 62 | 72 | 191 |
| Example 31 | | | | | | | | | |
| Comparative | 4 | 2.2 | 63 | 220 | 3.5 | 25.5 | 60 | 72 | 173 |
| Example 32 | | | | | | | | | |

The present application is based on Japanese Patent Application No. 2012-007424 filed on Jan. 17, 2012, the contents of which are incorporated herein by reference.

### INDUSTRIAL APPLICABILITY

The polyacetal resin composition of the present invention has excellent dimensional accuracy and can maintain an initial electroconductive level even after being slid for a long period. For this reason, the polyacetal resin composition of the present invention can be integrated with other materials and molded into a complicated shape. The polyacetal resin composition of the present invention can be preferably and extensively utilized in fields such as automobiles, precision parts for electrical and electronic devices, and other industries. Since the polyacetal resin composition of the present invention has excellent electroconductivity after being slid with the other materials, the polyacetal resin composition can be particularly preferably utilized for mechanism parts such as gears, flanges, and bearings.

### REFERENCE SIGNS LIST

1 to 14: barrel zones of extruder (separately independent)
15: die head
16: extruder motor
17: constant feeder (top feeder 1)
18: constant feeder (top feeder 2)
19: constant feeder (side feeder 1)
20: constant feeder (side feeder 2)
21: constant feeder (side feeder 3)
22: deaerating vent

1. A polyacetal resin composition comprising 100 parts by mass of a polyacetal resin (A) and 5 to 30 parts by mass of an electroconductive carbon black (B),
wherein the polyacetal resin composition has a volume resistivity of 10² Ω·cm or less measured based on JIS K 7194, and
a melt flow rate (MFR) of 8 g/10 min or more and 30 g/10 min or less as measured at a temperature of 190° C. and a load of 2.16 kg based on JIS K 7210.

2. The polyacetal resin composition according to claim 1, wherein the melt flow rate (MFR) as measured at the temperature of 190° C. and the load of 2.16 kg based on JIS K 7210 is 10 g/10 min or more and 30 g/10 min or less.

3. The polyacetal resin composition according to claim 1, wherein the melt flow rate (MFR) as measured at the temperature of 190° C. and the load of 2.16 kg based on JIS K 7210 is 12 g/10 min or more and 30 g/10 min or less.

4. The polyacetal resin composition according to claim 1, further comprising an epoxy compound (C).

5. The polyacetal resin composition according to claim 1, further comprising an aliphatic alcohol, and/or an ester being formed from a fatty acid and an aliphatic alcohol.

6. The polyacetal resin composition according to claim 1, further comprising an olefin resin.

7. The polyacetal resin composition according to claim 1, further comprising one or more selected from the group consisting of a polyolefin wax, a paraffin wax, a carnauba wax, and a polyamide wax.

8. The polyacetal resin composition according to claim 1, wherein a ratio V₁/V₂ of a melt viscosity V₁ measured under conditions of 210° C. and a shear rate of 100 s⁻¹ based on JIS K 7199 to a melt viscosity V₂ measured under conditions of 210° C. and a shear rate of 1000 s⁻¹ is 1.2 or more and 2.5 or less.

9. The polyacetal resin composition according to claim 1, wherein an amount of residue when being incinerated for 1 hour under conditions of an air atmosphere and 500° C. is 10% by mass or more.

10. A molded product comprising the polyacetal resin composition according to claim 1.

11. A molded product comprising the polyacetal resin composition according to claim 2.

12. A molded product comprising the polyacetal resin composition according to claim 3.

13. A molded product comprising the polyacetal resin composition according to claim 4.

14. A molded product comprising the polyacetal resin composition according to claim 5.

15. A molded product comprising the polyacetal resin composition according to claim 6.

16. A molded product comprising the polyacetal resin composition according to claim 7.

17. A molded product comprising the polyacetal resin composition according to claim 8.

18. A molded product comprising the polyacetal resin composition according to claim 9.
